(19) United States
(12) Patent Application Publication
(10) Pub. No.: US 2015/0103678 A1
(43) Pub. Date: Apr. 16, 2015

(54) IDENTIFICATION OF USER HOME SYSTEM IN A DISTRIBUTED ENVIRONMENT

(71) Applicant: FON Wireless Limited, London (GB)

(72) Inventors: Joan FISBEIN, Madrid (ES); Lander Alonso, Madrid (ES)

(73) Assignee: FON Wireless Limited, London (GB)

(21) Appl. No.: 14/050,824

(22) Filed: Oct. 10, 2013

(51) Int. Cl. H04W 24/08

(52) U.S. Cl. CPC H04W 24/08
USPC 370/252

(57) ABSTRACT

Described is a method of identifying a home network of a user, for example, a roaming user connecting using a Wi-Fi connection, for example, via a wireless router, based on a user identification received by a first device of the network visited by the user. If the authentication device of the visited network cannot determine the home network of the user based on the user identification, then it queries a core platform, which may be outside the first network. The core platform queries nodes associated with possible home networks and, based on the responses received from the nodes, determines the home network of the user. The user can then be authenticated using the home network information.

### BACKGROUND

1. Field of the Disclosure

The present invention relates generally to the field of authenticating a user visiting a network, and more particularly to determining a home network for a user accessing through a wireless LAN based on user identification.

2. Related Art

To identify or to authenticate a user who wishes to connect to the Internet, for example, via a Wi-Fi hotspot service, a captive portal is typically loaded that is associated with the network of the local AAA (Authentication Authorization and Accounting) module. The user's ID may be stored locally by the hotspot operator or by the network, and thus user can be authenticated.

However, in the case of a roaming user, no information may be locally available to authenticate the user. Further, if the AAA module of the visited network lacks information about the roaming user's home network, then the AAA module cannot know what server to contact to authenticate the roaming user.

Moreover, it is possible for a user who registers a network device, such as a wireless router, in his home to obtain free or discounted access to the Internet when roaming. Such a user can receive such roaming rights, in exchange for allowing the wireless router in his home that he has registered to be used by other members of the service who have registered their wireless routers to be used by others. Thus, a roaming user can visit a network, and the AAA module of the visited network would have no information about the roaming user that is locally stored sufficient to authenticate the roaming user. The AAA module of the visited network would even lack locally the information necessary to determine the home network of the roaming user, unless the roaming user himself provides the home network information.

Typically, the roaming user is prompted to identify his home network. For example, a list of possible home networks may be displayed as part of a captive portal to the roaming user, and the roaming user would select his home network. Based on this information, the AAA module of the visited network can query the visitor's home network AAA module to authenticate the user.

The user has to provide this additional home network information, making it more difficult for a roaming user to connect to the network. However, as the number of possible home networks increases, the list of possible home networks from which the roaming user has to select has increased in size.

In addition, a user's home network may be identified based on a realm that is understood from the user ID. Often, for example, an e-mail address of a user is used as a user's user ID. For example, the user may belong to a network such as British Telecom, and the user's address may include the word British Telecom, BT, or a variation or abbreviation thereof.

In the case of a mobile network, a subscriber identification is made based on the International Mobile Subscriber Identity (IMSI) that each subscriber is assigned. When mobile networks were designed, the IMSI of each subscriber was chosen to identify the country and operator using the IMSI. In this way, the visited network can easily identify the home network of each subscriber and can correctly perform the authentication process. This works well for cellular telephone networks.

Many if not most e-mail addresses do not indicate the identity of the provider or provide any indication of the user's home network. Rather, many e-mail addresses indicate the name of the e-mail service provider, such as “Yahoo.” Therefore, there is no guarantee that the realm shown in the e-mail address of the user identifies a home network. Sometimes, a prefix or suffix has been added to the user ID or e-mail address when the roaming user selects his home network from a list provided in a captive portal. In such a case, a prefix or a suffix can be used to identify the realm of the home network. A user ID with such a prefix or suffix added is sometimes known as the Roaming User Name (RUN). However, such a solution requires a user to identify the home network so that the prefix or suffix can be added.

Various related technologies are known. Gutman, U.S. Pat. No. 6,298,383, discloses that when a user attempts to log-in by dialing into a network access server of an ISP (Internet Service Provider), the network access request from the network access server is forwarded to a Protocol Gateway (PG) for processing, and that if the PG determines, upon processing the fully qualified domain name of the user, that the user's domain is to be processed directly at the AAA service of the network, then the access requested is forwarded to the AAA service and processed there in a conventional manner. Further, Gutman discloses that if, on the other hand, the fully qualified domain name processed by the PG indicates that the user is to be authenticated remotely, then the PG forwards a network access request to a proxy server or a GRS (Global Roaming Service) server for proxy processing. At this point, the proxy/GRS server looks up the user's domain AAA contact information from the database associated with the proxy/GRS server, and then the proxy/GRS server proxies the access request to the now-identified remote AAA service at the user's domain site, and processing can be performed there in a conventional manner.

Sanchez Herrero, U.S. Pat. No. 7,296,078 discloses a user selector proxy as an entry point for a AAA service network within an ISP network. Sanchez Herrero discloses that a storage included in USP includes relevant AAA server data, each AAA server being in charge of a specific group of users, and that when a AAA service requests from a AAA client is received, the USP extracts all relevant user identifier fields and consults an internal data storage to determine and address a preferred AAA server in charge of the user, and directs the AAA service request to the AAA server. The prior art does not provide a core node that polls possible home networks and identifies the home network to an authorization module based on the responses received.

### SUMMARY

Other features and advantages of the present invention will become apparent from the following description of the invention, which refers to the accompanying Drawings.

Described is a non-transitory processor-readable medium comprising instructions configured to cause, when executed by a processor of a user identification service core node, identification of a home network of a user based on a user identification of the user received by a first module of a first network visited by the user, the instructions comprising:

user identification receiving instructions configured to receive the user identification from a querying user identification service node of the first network, the querying user identification service node being associated with the first module of the first network;
node querying instructions configured to query at least two target user identification service nodes as to whether the user identification belongs to one of the at least two target user identification service nodes, each node of the at least two target user identification service nodes associated with a respective network of a plurality of networks, and to receive a response from each of the at least two target user identification service nodes; and
reply providing instructions configured to determine the home network of the user based on the response received from each of the at least two target user identification service nodes, and to transmit to the querying user identification service node of the first network a reply indicating the home network determined.

In this medium, the first module may be an authentication, authorization and accounting module, and each node of the at least two target user identification service nodes is associated with an authorization, authentication and accounting module.

In this medium the response from a first target node of the at least two target user identification service nodes may indicate that the respective network associated with the first target node is not the home network of the user, and the response from a second target node of the at least two target user identification service nodes may indicate that the respective network associated with the second target node is the home network of the user.

Also described is a system comprising the non-transitory processor-readable medium and the querying user identification service node associated with the first network, wherein the querying user identification service node is configured:

to determine whether the first network is the home network of the user;
then, if the querying user identification service node determines that the first network is not the home network of the user, to transmit a query containing the user identification received by the user identification service core node; and
to receive the reply transmitted by the user identification service core node and to provide an indication of the home network of the user to the first module.

In such a system, the querying user identification service node may be further configured:

to attempt to identify, if the querying user identification service node determines that the first network is not the home network of the user, the home network of the user based on the user identification by referring to a local memory,
wherein the transmitting the query is performed only if the attempt to identify the home network fails.

In such a system, the querying user identification service node may be further configured to receive from the first module a query for the home network of the user, before determining whether the first network is the home network of the user.

The querying user identification service node may be further configured:

to attempt to find the user identification in a memory provided in the first network; and
to transmit the query containing the user identification received by the user identification service core node, only if the attempt to find the user in the memory fails to find the user in the memory and the querying user identification service node determines that the first network is not the home network of the user.

The querying user identification service node may be further configured to provide, based on the indication of the home network of the user received from the user identification service core node, a roaming user name of the user to the first module.

The system may further include the first module, wherein the first module is an authentication, authorization and accounting module of the first network; and the first module authenticates the user based on the user identification and based on the indication of the home network of the user received from the user identification service core node.

In this system, the querying user identification service node may attempt to identify the home network of the user by applying rules regarding user identification realms of the plurality of networks.

The querying user identification service node may further comprise:

rule receiving instructions configured to receive a set of rules indicating signal transmitted by the user identification service core node,
wherein the querying user identification service node performs the applying of the rules based on the rules indicating signal received.

Also contemplated is a system comprising an authentication core module and a user identification service core node configured to identify a home network of a user based on a user identification of the user received by a first module of a first network visited by the user, the system comprising: the authentication core module configured to receive a query including a user identification from an authentication node of the first network to authenticate the user, the query indicating that the authentication node of the first network lacks information about an identity of the home network of the user and that the first network is not the home network of the user, and to provide the user identification to the user identification core node;

the user identification core node configured:
to query, in response to the providing of the user identification by the user information core node, at least two target user identification service nodes as to whether the user identification belongs to one of the at least two target user identification service nodes, each node of the at least two target user identification service nodes associated with a respective network of a plurality of networks;
to receive a response from each of the at least two target user identification service nodes;
to determine the home network of the user based on the response received from each of the at least two target user identification service nodes; and
the authentication core module is further configured to authenticate the user based on the home network determined by the user identification core node.

Also described is a method of identifying a home network of a user based on a user identification of the user received by a first device of a first network visited by the user, the method comprising:

determining automatically, by the first device, whether the first network is the home network of the user, the first device comprising a data processor;
attempting automatically to identify, by the first device of the home network, if the first network is not the home network of the user, the home network of the user based on the user identification by referring to a local memory;
transmitting automatically over an electronic network, by the first device of the first network, a query containing the user identification to a core node of a core platform outside the first network, wherein the transmitting the query is performed only if the attempt to identify the home network fails to identify the home network, the core node comprising a data processor;
querying automatically at least two target user identification service nodes as to whether the user identification belongs to one of the at least two target user identification service nodes, each node of the at least two target user identification service nodes associated with a respective network of a plurality of networks;
receiving a response from each of the at least two target user identification service nodes; and
determining automatically the home network of the user based on the response received from each of the at least two target user identification service nodes; and
authenticating automatically the user according to the home network determined.

According to this method, the first device may be an authentication, authorization and accounting module of the first network.

In this method, the authenticating may be performed by the first device based on the user identification and based on the determination of the home network of the user.

Further, the authenticating may be performed by an authorization module of the core platform.

The method may additionally include determining a roaming user name of the user based on the determined home network,

wherein the authenticating of the user is performed based on the roaming user name.

The user identification may comprise an email address of a user.

The user identification of the user received by the first device may be received from a network device providing automatically wireless access to a wireless user device comprising a data processor, and the user identification is received from the wireless user device by the network device.

### BRIEF DESCRIPTION OF THE DRAWINGS

For the purposes of illustrating the invention, in the Drawings illustrate embodiments that are presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates a roaming user in relation to a visited network and the home network, according to the prior art.

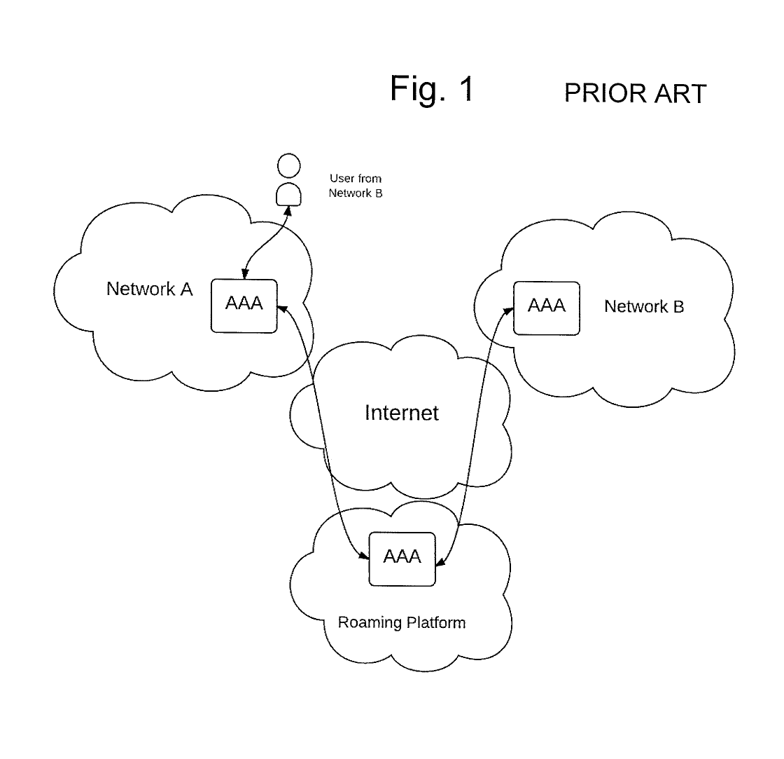

FIG. 2 illustrates an example of the visited network user identification service, a user identification service core node, a home network user identification service, according to an aspect of the present disclosure.

FIG. 3 illustrates an example of a user identification service core node and a user identification service node, according to an aspect of the present disclosure.

FIG. 4 illustrates an example of a user device connecting using Wi-Fi to a service device of a first network, according to an aspect of the disclosure.

FIG. 5 is an example of a method or process for authenticating a user by a first module of a visited network based on the home network identified by the core platform according to an aspect of the present disclosure.

FIG. 6 is an example of a process or a method flowchart showing a core authentication module authenticating a user based on a user identification and based on an identification of the user's home network determined by a core node, according to an aspect of the present disclosure.

### DETAILED DESCRIPTION OF THE EMBODIMENTS

Described below with reference to the Drawings are a method, a system, a computer-readable medium and a means for performing the method, according to aspects of the present disclosure.

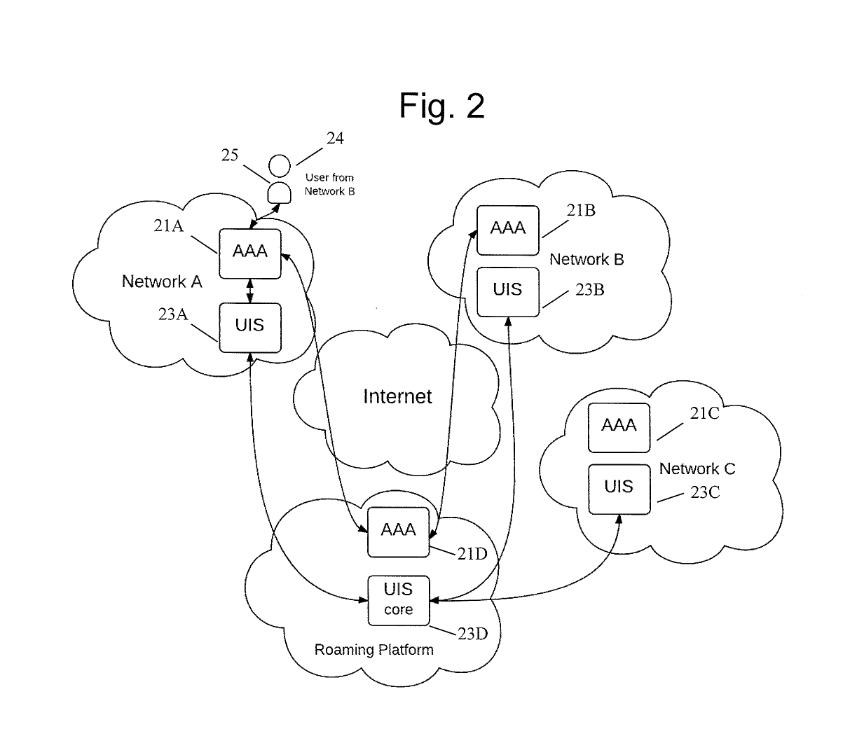

FIG. 2 illustrates that user using user device 24 connecting via a network device, such as a Wi-Fi hotspot provided by, for example a wireless router, or the like, tries to access Network A. For example, the user device may be a handheld or other portable device. FIG. 2 also illustrates that Network A includes an authentication, authorization and accounting module, which communicates with an authentication, authorization and accounting module provided on a roaming platform via the Internet, which in turn communicates via the Internet with an authentication, authorization and accounting module on Network B.

User device 24 may be a roaming device that looks for Wi-Fi networks through which to connect to the Internet, so that the user device, using a browser, for example may visit Internet resources, send and receive e-mail, use VoIP (voiceover IP) or send and/or receive other types of data. For example, the user may be at a cafe, hotel lobby, airport or other type of public hotspot. Alternatively, the user device may be attempting to access a network provided by a privately owned wireless router. For example, a company such as FON allows a user to register a wireless router in the user's home or office or other private premises or the like, to allow members of the FON community free or substantially discounted access to the Internet when within the radio range of the wireless router. In exchange for registering the wireless router in this way, the user becomes a member of the FON community and can similarly access the web when roaming and in radio range of another member's wireless router. Thus, when the roaming user's device detects that he or she is within range of a local area wireless network provided by a member of the FON community, then he can provide user identification through the user device and access the Internet through the local member's Wi-Fi router network.

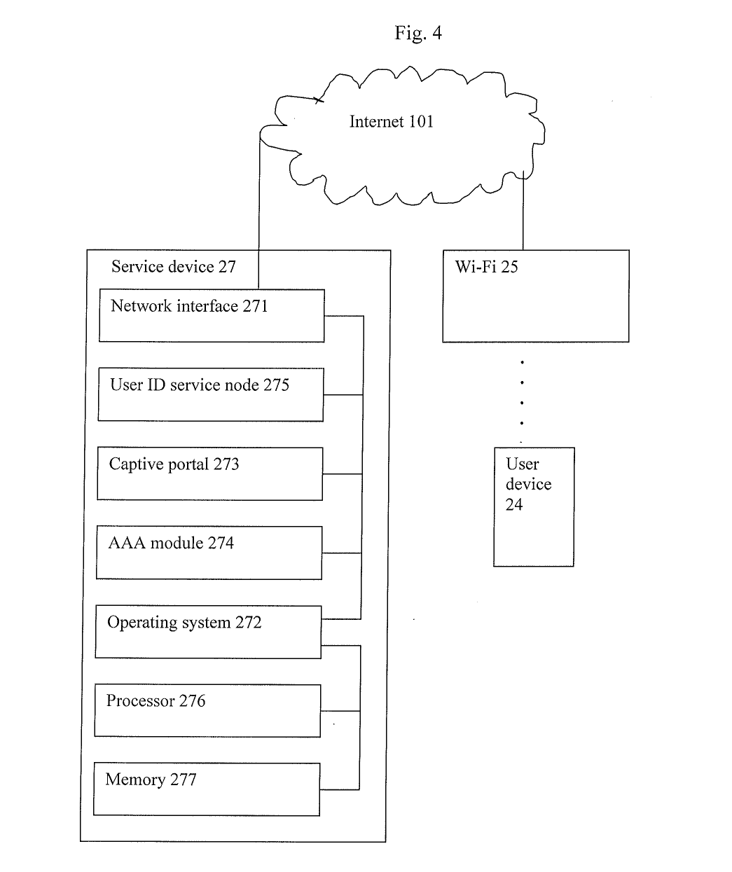

FIG. 2 illustrates that the AAA module of each network is provided with a UIS (User Identification Service) node and that a central UIS core node is provided at a roaming platform. Networks A, B, and C are connected via the Internet. FIG. 2 illustrates that Network A includes an authentication, authorization and accounting module 21A, Network B includes an authentication, authorization and accounting module 21B, and Network C includes an authentication, authorization and accounting module 21C, while roaming platform located outside of Networks A, B and C, includes a core authentication, authorization and accounting module 21D. Further, FIG. 2 illustrates that each of the authentication, authorization and accounting modules 21A-21C is connected, respectively, to user identification service nodes 23A-23C, located respectively in each of the Networks A-C, and that the roaming platform includes user information core module 23D. It will be understood that more than three and fewer than three of such networks can be provided, each network comprising a UIS node or a node comparable to a UIS node. It will be further understood that each UIS node can comprise more than one device or more than one server, and that while FIG. 4 illustrates the service device 27 as being comprised of a single device, it would be understood that modules 273-275 may be provided as separate devices or groups of devices. The AAA module of each network can be associated with a UIS node, while a central platform for authorizing users can be associated with the UIS core node.

FIG. 4 illustrates user device 24 attempting to connect to the Internet 101 via Wi-Fi device 25. Wi-Fi device 25 connects with service device 27 through a network interface 271 of service device 27. User device 24 is then showed a page provided by captive portal 273, which prompts the user of user device 24 to enter user identification, for example, an e-mail address and a password. For example, wireless internet service provider, an internet service provider or another provider may provide service device 27 for authenticating the user. FIG. 4 also illustrates a service device 27 that includes operating system 272 connected to captive portal 273, AAA module 274, user ID service node 275, processor 276 and memory 277.

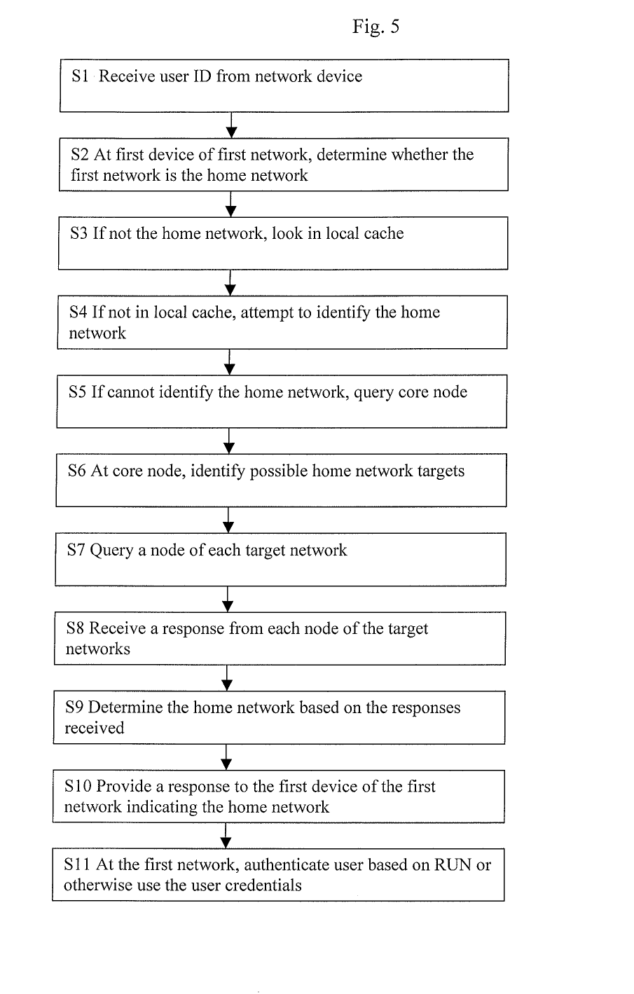

For example, the response to the captive portal can be used to create a RADIUS access request that is sent to the AAA module 274. The AAA module can then send the user ID field to the local UIS node. Eventually, as described below and as illustrated in the flowchart shown in FIG. 5, the UIS node returns the user ID with any prefix or suffix needed for the AAA to process the authorization of the user, for example to provide the RUN to the AAA module. The UIS node can also return an indicator of the home network of the user in a separate field, to be used if required by the AAA module.

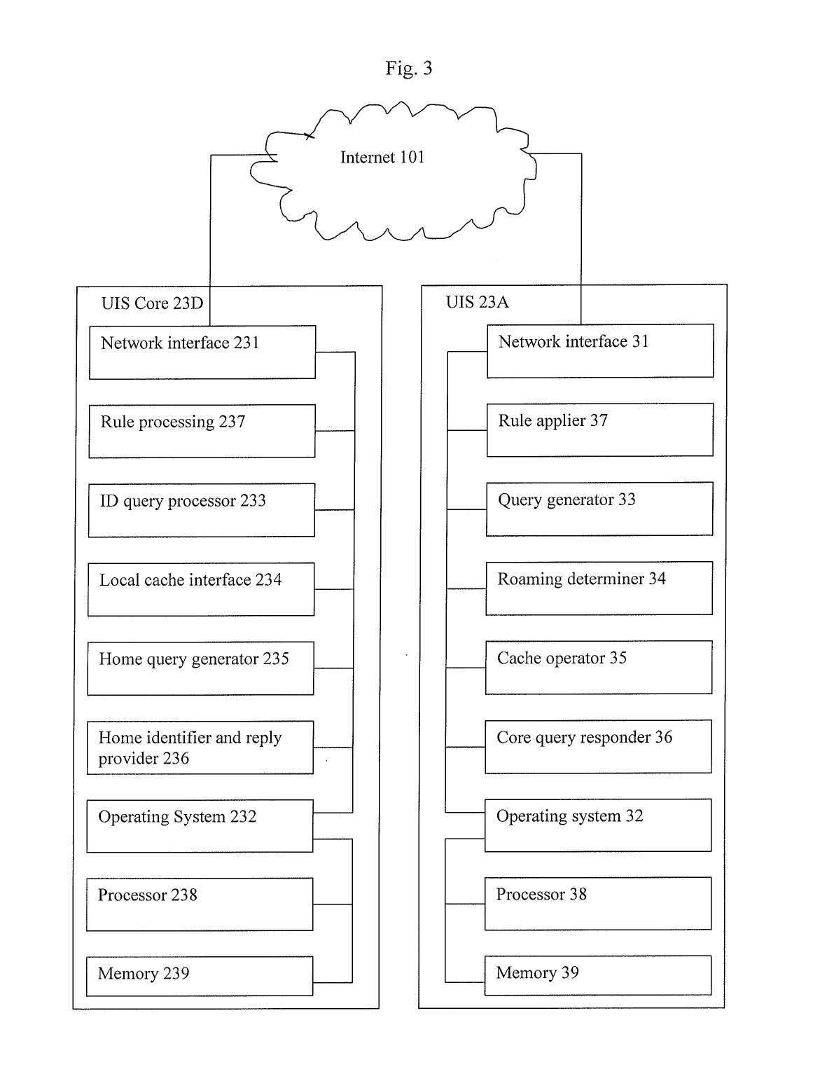

FIG. 5 illustrates a flow chart with step 1, receive user ID from network device, step 2, at first device at the first network, determine whether the first network is the home network, at step 3, if it is determined that it is not the home network, look in local cache, at step 4, if it is not in the local cache, attempt to identify the home network, at step 5, if the home network cannot be identified, query the core UIS node, at step 6, at the core node, identify possible home network targets, at step 7, query a node of each of the target networks, at step 8, receive a response from each node of the target network, at step 9, determine the home network based on the responses received, at step 10, provide a response to the first device of the first network indicating the home network, and at step 11, at the first network authenticate the user based on the RUN, or otherwise use the user credentials now obtained together with the home network. FIG. 3 illustrates user identification service core node 23D connected via the Internet 101 to user information service node 23A positioned in Network A. UIS core node 23D includes network interface 231, operating system 232, ID query processor 233, local cache interface 234, home query generator 235, home identifier and reply provider 236, rule processing 237, processor 238 and memory 239. UIS node 23A includes network interface 31, operating system 32, query generator 33, roaming determiner 34, cache operator 35, core query responder 36, rule applier 37, processor 38 and memory 39.

Service device 27 includes the AAA module 274 that attempts to authenticate the user by first identifying the home network of the user. For example, AAA module 274 may pass a user ID to user ID service node 275 of service device 27. It will be understood that while shown as part of the same device, user ID service node 275 may be a separate device or may be a separate group of devices or may be located offsite from AAA module 274.

User ID service node 275 can determine if the user ID belongs to a user of the local network and can parse the user ID to attempt to identify the home network, if the user ID is not part of the realm of the visited network.

If user ID service node 275 determines that the user ID does not belong to the home network, and the home network cannot be determined based on the user ID, then the user ID service node 275 may transmit a query to UIS core node 23D illustrated in FIG. 2. For example, user ID service node 275 can consult a local cache, shown in FIG. 3 as memory 239, using local cache interface 234. The local cache may store the RUN (Roaming User Name) of roaming users who have recently or over a predefined period of time visited the first network (the visited network in an example illustrated) or other identifying information identifying the home network of recently visiting roaming users.

When queried by user ID service node 23A, UIS core node 23B can identify the target user identification service nodes to which to send a home network query. That is, UIS core node 23D may send the home network query to the UIS nodes 23B and 23C of networks B and C, respectively, which UIS core node 23D identifies as being possibly associated with the home network of the roaming user.

In response to the query from UIS core node 23D, UIS nodes B and C respond with a response indicating whether the user belongs to that network. Thus, UIS node 23B responds that user identification belongs to it because it is the home network, while UIS node 23C responds that the user identification is not part of network C, and thus is not the home network of the roaming user. UIS core node 23D receives the response from each UIS target node, and home identifier and reply provider 236 of UIS core node 23D (illustrated in FIG. 3) determines the home network based on the responses received. At this point the home identifier and reply provider 236 generates a response to be sent to the visited network, Network A, indicating the home network, Network B, of the roaming user. For example, the reply can be sent to UIS node 23A, UIS node 23A can then forward this information to AAA node 21A. With the home network known, AAA node can authenticate the user.

The client list of the UIS module 23A can be the service AAA module, for captive portal and WISPr (Wireless Internet Protocol roaming) authentication, the EAP (Extensible Authentication Protocol) AAA, for EAP authentication, and other systems, to obtain service-wide parameters for a user. For example, platform-wide URLs can be made available for customer care, user zone login or similar services. Users could remember them easily and then, internally, their home system would be detected in order to provide them an adequate response or redirection.

When launched, UIS modules may have little information, other than information saved in the local cache about recently roaming users, in addition to the information available at the local service device 27. Rules governing the Class I realms can be provided by rule processing 237 of UIS core 23D (illustrated in FIG. 3) to each UIS node 23A-23B-23C, and the like. A Class I realm is one in which the user identification identifies the home network of the user. For example, the rule can delineate which e-mail addresses belong to which network as their home network, for Class I realms. For example, if a service device 27 has one or several realms associated to itself alone, and they are not present in other service devices, then the service device 27 may be considered Class I.

Class II service devices are ones that do not own any realm of their users. For example, some user IDs may be from Gmail, while others may be from Yahoo and still be used as user IDs in a telecom company different from the previous ones. For roaming users belonging to Class II service devices, UIS node 23A has to invoke the services of UIS core node 23D. Once done so, the UIS core node 23D sends a query to the UIS target nodes 23B and 23C, as discussed above. When a new service device 27 is added for a network, the service device 27 is registered in the UIS core node 23D indicating its class type and realm rules for Class I service devices.

A home network identifier can be strong such as “BT” or other name that identifies a single service device 27 among all service devices that are interconnected.

The UIS core would be reachable through a DNS entry such as UIS.FON.com or some other DNS entry that identifies the UIS core node.

When first booting, the UIS node 275 of a service device 27 can read the associated configuration file to retrieve the information that allows entering working mode, in which it can extract its own home network identifier. This information can be used to query the UIS core node. The core node can reply with the information related to itself and to all Class I service devices, such as Service device name: BT, Service device class: Class I, and associated rules. With this information, service device 27 will know if it is a Class I or Class II service device. It can then configure itself to detect users that belong to its home network. In case it is a Class I device, it will employ the provided rules for its home network identifier. In case it is a Class II device, it will configure itself to communicate with the authentication server where the user credentials are stored, that being locally available within the service device 27 or available externally. The UIS module can then load the rest of the Class I rules into memory for processing user IDs, and the remaining rules can be placed for use after the local user detection. It will be understood that more than one UIS core node 23D can be provided, and that the load can be handled and distributed using a load balancer.

In addition, it also may be possible to store the rules for each of the networks in a configuration file accessible by the UIS node of that network. Then, at the boot-up process, periodically, when a new network is added or a network is updated, or as necessary from time to time, the UIS node of each Class I sends its rule set to the UIS core node, and the UIS core node later relays the rules to the rest of the UIS nodes.

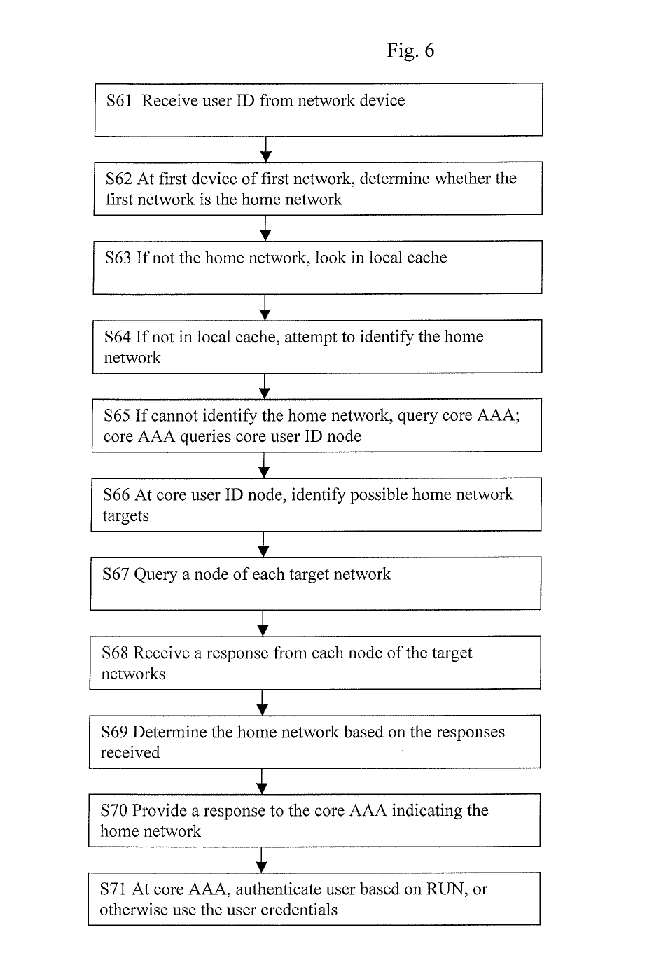

According to another aspect of the disclosure as illustrated in the flowchart shown in FIG. 6, the identification process may be integrated within the roaming authentication procedure and performed at the core AAA module. FIG. 6 is a flowchart that illustrates steps performed according to this aspect of the disclosure. At step 61, the user ID is received from the network device, at step 62, at the first device of the first network, it is determined whether the first network is the home network, at step 63, if it is determined that the visited network is not the home network, then the first device looks in the local cache, at step 64, if it is not in the local cache, an attempt is made to identify the home network locally, at step 65, if the home network cannot be identified, the core AAA is queried, and the core AAA queries the core user ID node, passing it the user identification, at step 66, the core user ID node identifies the possible home network targets, and at step 67, a node of each target network is queried as to whether the user identification belongs to it, at step 68, a response is received from each node of the target networks, and at step 69, the home network is determined based on the responses received, at step 70, a response is provided to the core AAA indicating the home network, and at step 71, at the core AAA, the user is authenticated based on the RUN, or the user credentials are otherwise used as necessary.

According to this aspect of the disclosure, when the UIS node receives a request for authentication purposes for a given user ID, it attempts to identify the home network of the user. If the UIS node determines that it cannot determine the identity of the home network, then instead of querying directly the UIS core node, as described above and as shown in FIG. 5, UIS node can return a reply of unknown to the AAA module. The AAA module can then proceed with the authentication process by specifying that the home network of the roaming user is unknown. Then, a query is issued to the roaming platform's AAA system for authenticating the user.

The roaming platform is a platform with which the UIS core node 33D is associated. The roaming platform may be located in FON premises, and takes care of performing the AAA related receives for roaming scenarios.

Having received this query, AAA node 21D proceeds by authenticating the user, and if it cannot, that is, if no home network for the user is identified, then the roaming platform AAA module 21D returns an access denied response. According to this aspect of the present disclosure, delay in the authentication process can be reduced for a roaming user. This can be achieved in the case of the authentication of roaming users from a Class II network. In this approach there is no need for a UIS node 23A to query the UIS core node 23D and to wait for the response to then send another request through the AAA system; the hop from the service device 27 to the roaming platform is only made once.

While described primarily as necessary for authentication identifying a home network of a user may also be important for other processes. For example, an autonomous online service or a webpage that has its own user base may also need to know the home network of a user.

User device 24 may be any type of computer, cable of communicating with a second processor, including a laptop, notebook, netbook, smartphone, e-reader or other hand held device or tablet. Mobile client applications can be provided on iOS and android devices, as well as other types of phones and handheld and portable devices. An Apache web server may be used running on LINUX. However, it will be understood that other systems may also be used. The user identification service nodes and the user identification service core node may each be comprised of one or more processor-driven devices, including portable devices, or may be provided as part of a system of several devices working in tandem, or may integrate the functionality of a number of devices.

The present methods, functions, systems, computer-readable medium product, or the like may be implemented using hardware, software, firmware or a combination of the foregoing, and may be implemented in one or more computer systems or other processing systems, such that no human operation may be necessary. That is, the methods and functions can be performed entirely automatically through machine operations, but need not be entirely performed by machines. Similarly, the systems and computer-readable media may be implemented entirely automatically through machine operations but need not be so. Computer systems as described herein may include one or more processors in one or more units for performing the system according to the present disclosure and these computers or processors may be located in a cloud or may be provided in a local enterprise setting or off premises at a third party contractor. Similarly, the information stored may be stored in a cloud or may be stored locally or remotely.

The computer system or systems for interacting with a user can include a GUI (Graphical User Interface), or may include graphics, text and other types of information, and may interface with the user via desktop, laptop computer or via other types of processors, including handheld devices, telephones, mobile telephones, smart phones or other types of electronic communication devices and systems. A computer system for implementing the foregoing methods, functions, systems and computer-readable storage medium may include a memory, preferably a random access memory, and may include a secondary memory. Thus, database may be part of the same machine or may be located off site, and may be implemented as a floppy disk drive, magnetic tape drive, an optical disk drive, removable storage drive, a combination of the foregoing or any type of recording medium. Examples of a memory or a computer-readable storage medium product include RAM, ROM, a removable memory chip, such as an erasable programmable read-only memory (EPROM), a programmable read-only memory (PROM), an external memory, a peripheral memory, a removable storage unit or the like.

The communication interface may include a wired or wireless interface communicating over TCP/IP paradigm or other types of protocols, and may communicate via a wire, cable, fire optics, a telephone line, a cellular link, a radio frequency link, such as WI-FI or Bluetooth, a LAN, a WAN, VPN, the world wide web or other such communication channels and networks, or via a combination of the foregoing.

In an embodiment, the present application employs regards the extensible authentication protocol (“EAP”), an authentication framework that is frequently used in wireless networks and Point-to-Point connections. EAP is widely used, for example, in IEEE 802.11 (Wi-Fi), and WPA and WPA2 standards have adopted IEEE 802.1X with multiple EAP types for authentication mechanisms. When used as an authentication protocol, EAP is usable on the captive portal, and is suitable when used with WPA and/or WPA2. For example, LEAP (Lightweight-EAP), EAP-TLS, EAP-TTLS, EAP-FAST, EAP-SIM, EAP-AKA are applicable in association with one or more credentials and/or processes. In an embodiment, 802.1X involves a supplicant (e.g., a mobile computing device such as a smartphone, PDA or the like), an authenticator (e.g., a configured router) and a server. 802.1X may be used to transport EAP messages via EAP over Lan (“EAPOL”) from a supplicant to an authenticator, and thereafter via RADIUS/Diameter from authenticator to the server.

In such embodiment(s), a universal access method (“UAM”) is used to transport password authentication protocol (“PAP”) messages. Thereafter, HTTPs may be used for transporting data from supplicant to a UAM Server, HTTP is used from supplicant to authenticator, and RADIUS is used from Authenticator to Server.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A non-transitory processor-readable medium comprising instructions configured to cause, when executed by a processor of a user identification service core node, identification of a home network of a user based on a user identification of the user received by a first module of a first network visited by the user, the instructions comprising:
user identification receiving instructions configured to receive the user identification from a querying user identification service node of the first network, the querying user identification service node being associated with the first module of the first network;
node querying instructions configured to query at least two target user identification service nodes as to whether the user identification belongs to one of the at least two target user identification service nodes, each node of the at least two target user identification service nodes associated with a respective network of a plurality of networks, and to receive a response from each of the at least two target user identification service nodes; and
reply providing instructions configured to determine the home network of the user based on the response received from each of the at least two target user identification service nodes, and to transmit to the querying user identification service node of the first network a reply indicating the home network determined.

2. The non-transitory processor-readable medium of claim 1, wherein the first module is an authentication, authorization and accounting module, and each node of the at least two target user identification service nodes is associated with an authentication authorization, and accounting module.

3. The non-transitory processor-readable medium of claim 1, wherein the response from a first target node of the at least two target user identification service nodes indicates that the respective network associated with the first target node is not the home network of the user, and the response from a second target node of the at least two target user identification service nodes indicates that the respective network associated with the second target node is the home network of the user.

4. A system comprising the non-transitory processor-readable medium of claim 1, and the querying user identification service node associated with the first network, wherein the querying user identification service node is configured:
to determine whether the first network is the home network of the user;
then, if the querying user identification service node determines that the first network is not the home network of the user, to transmit a query containing the user identification received by the user identification service core node; and
to receive the reply transmitted by the user identification service core node and to provide an indication of the home network of the user to the first module.

5. The system of claim 4, wherein the querying user identification service node is further configured:
to attempt to identify, if the querying user identification service node determines that the first network is not the home network of the user, the home network of the user based on the user identification by referring to a local memory,
wherein the transmitting the query is performed only if the attempt to identify the home network fails.

6. The system of claim 4, wherein the querying user identification service node is further configured to receive from the first module a query for the home network of the user, before determining whether the first network is the home network of the user.

7. The system of claim 4, wherein the querying user identification service node is further configured:
to attempt to find the user identification in a memory provided in the first network; and
to transmit the query containing the user identification received by the user to the identification service core node, only if the attempt to find the user in the memory fails to find the user in the memory and the querying user identification service node determines that the first network is not the home network of the user.

8. The system of claim 4, wherein the querying user identification service node is further configured to provide, based on the indication of the home network of the user received from the user identification service core node, a roaming user name of the user to the first module.

9. The system of claim 4, further comprising the first module, wherein the first module is an authentication, authorization and accounting module of the first network; and
the first module authenticates the user based on the user identification and based on the indication of the home network of the user received from the user identification service core node.

10. The system of claim 4, wherein the querying user identification service node attempts to identify the home network of the user by applying rules regarding user identification realms of the plurality of networks.

11. The system of claim 10, wherein the querying user identification service node further comprises:
rule receiving instructions configured to receive a set of rules indicating signal transmitted by the user identification service core node,
wherein the querying user identification service node performs the applying of the rules based on the rules indicating signal received.

12. A system comprising an authentication core module and a user identification service core node configured to identify a home network of a user based on a user identification of the user received by a first module of a first network visited by the user, the system comprising:
the authentication core module configured to receive a query including a user identification from an authentication node of the first network to authenticate the user, the query indicating that the authentication node of the first network lacks information about an identifier of the home network of the user and that the first network is not the home network of the user, and to provide the user identification to the user identification core node;
the user identification core node configured:
to query, in response to the providing of the user identification by the core node, at least two target user identification service nodes as to whether the user identification belongs to one of the at least two target user identification service nodes, each node of the at least two target user identification service nodes associated with a respective network of a plurality of networks;
to receive a response from each of the at least two target user identification service nodes;
to determine the home network of the user based on the response received from each of the at least two target user identification service nodes; and
the authentication core module is further configured to authenticate the user based on the home network determined by the user identification core node.

13. A method of identifying a home network of a user based on a user identification of the user received by a first device of a first network visited by the user, the method comprising:
determining automatically, by the first device, whether the first network is the home network of the user, the first device comprising a data processor;
attempting automatically to identify, by the first device of the home network, if the first network is not the home network of the user, the home network of the user based on the user identification by referring to a local memory;
transmitting automatically over an electronic network, by the first device of the first network, a query containing the user identification to a core node of a core platform outside the first network, wherein the transmitting the query is performed only if the attempt to identify the home network fails to identify the home network, the core node comprising a data processor;
querying automatically at least two target user identification service nodes as to whether the user identification belongs to one of the at least two target user identification service nodes, each node of the at least two target user identification service nodes associated with a respective network of a plurality of networks;
receiving a response from each of the at least two target user identification service nodes; and
determining automatically the home network of the user based on the response received from each of the at least two target user identification service nodes; and
authenticating automatically the user according to the home network determined.

14. The method of claim 13, wherein the first device is an authentication, authorization and accounting module of the first network.

15. The method of claim 13, wherein the authenticating is performed by the first device based on the user identification and based on the determination of the home network of the user.

16. The method of claim 13, wherein the authenticating is performed by an authorization module of the core platform.

17. The method of claim 13, further comprising determining a roaming user name of the user based on the determined home network,
wherein the authenticating of the user is performed based on the roaming user name.

18. The method of claim 13, wherein the user identification of the user received by the first device is received from a network device providing automatically wireless access to a wireless user device comprising a data processor, and the user identification is received from the wireless user device by the network device.

19. The method of claim 13, wherein the user identification comprises an email address.
